(19) United States
(12) Patent Application Publication
(10) Pub. No.: US 2019/0057681 A1
(43) Pub. Date: Feb. 21, 2019

(54) SYSTEM AND METHOD FOR HEARING PROTECTION DEVICE TO COMMUNICATE ALERTS FROM PERSONAL PROTECTION EQUIPMENT TO USER

(71) Applicant: Honeywell International Inc., Morris Plains, NJ (US)

(72) Inventors: Nagaraju Rachakonda, Hyderabad (IN); LG Srinivasa Rao Kanakala, Hyderabad (IN); Mehabube Rabbanee Shaik, Hyderabad (IN)

(21) Appl. No.: 16/104,601

(22) Filed: Aug. 17, 2018

(30) Foreign Application Priority Data
Aug. 18, 2017 (IN) 201711029320

(51) Int. Cl. G10L 13/04; H04R 1/10; G10K 11/162; H04W 76/10; H04W 4/80

(52) U.S. Cl. CPC G10L 13/043; H04R 1/1083; H04R 1/1008; H04R 2420/07; H04R 1/1041; H04W 76/10; H04W 4/80; G10K 11/162

(57) ABSTRACT

Embodiments relate generally to systems and methods for communicating data from a personal protection equipment device to a headset. A method may comprise generating at least one message, by a personal protection equipment device, comprising information related to the personal protection equipment device; wirelessly communicating the generated message from the personal protection equipment device; receiving, by a hearing protection headset, one or more of the generated messages from the at least one personal protection equipment device; converting, by the hearing protection headset, the received message to speech format; and communicating, via one or more speakers within the heating protection headset, the converted message to the user.

### CROSS-REFERENCE TO RELATED APPLICATIONS

The present application claims priority to India Provisional Patent Application No. 201711029320 filed Aug. 18, 2017 by Nagaraju Rachakonda, et al. and entitled “System and Method for Hearing Protection Device to Communicate Alerts from Personal Protection Equipment to User” which is incorporated herein by reference as if reproduced in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

While working in an environment with high noise levels, a user may wear a headset that comprises noise reduction or cancellation devices. In some cases, a user may also wear personal protection equipment (PPE) configured to generate alerts and/or alarms while working in hazardous environments, such as a gas detector, a self-contained breathing apparatus (SCBA), a powered air purifying respirator (PAPR), and/or other protection equipment or environmental sensors.

### SUMMARY

In an embodiment, a wireless communication system may comprise at least one personal protection equipment device configured to generate messages and wirelessly communicate the generated messages; and a hearing protection headset comprising passive noise cancellation material configured to protect a user from harmful sound exposure; a wireless communication module configured to wirelessly receive one or more messages from the at least one personal protection equipment device, and convert the received message to speech format; and one or more speakers configured to communicate the converted message to the user.

In an embodiment, a method for communicating data from a personal protection equipment device to a headset may comprise generating at least one message, by a personal protection equipment device, comprising information related to the personal protection equipment device; wirelessly communicating the generated message from the personal protection equipment device; receiving, by a hearing protection headset, one or more of the generated messages from the at least one personal protection equipment device; converting, by the hearing protection headset, the received message to speech format; and communicating, via one or more speakers within the hearing protection headset, the converted message to the user.

In an embodiment, a hearing protection headset may comprise passive noise cancellation material configured to protect a user from harmful sound exposure; a wireless communication module configured to wirelessly receive one or more data messages generated by at least one personal protection equipment device; a converter configured to convert the received message to speech format; and one or more speaker configured to communicate the converted message to the user.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 illustrates a wireless communication system comprising a plurality of PPE devices according to an embodiment of the disclosure.

FIG. 2 illustrates another view of the communication system comprising a headset and a plurality of PPE devices according to an embodiment of the disclosure.

FIG. 3 illustrates a diagram of an electronics system of a headset according to an embodiment of the disclosure.

FIGS. 4A-4B illustrate perspective and exploded views of a headset according to an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

The following brief definition of terms shall apply throughout the application:

The term “comprising” means including but not limited to, and should be interpreted in the manner it is typically used in the patent context;

The phrases “in one embodiment,” “according to one embodiment,” and the like generally mean that the particular feature, structure, or characteristic following the phrase may be included in at least one embodiment of the present invention, and may be included in more than one embodiment of the present invention (importantly, such phrases do not necessarily refer to the same embodiment);

If the specification describes something as “exemplary” or an “example,” it should be understood that refers to a non-exclusive example;

The terms “about” or “approximately” or the like, when used with a number, may mean that specific number, or alternatively, a range in proximity to the specific number, as understood by persons of skill in the art field (for example ±10%); and

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

Embodiments of the disclosure include systems and methods for wirelessly communicating messages from one or more PPE devices to a hearing protection headset, and communicating the messages to a user via one or more speakers of the hearing protection headset.

Typically, hearing protection personal protection equipment (PPE) (such as earmuffs or earplugs) may be used in noisy environments to limit the sound exposure to a worker. Along with hearing PPE, a worker may also wear and/or carry other PPE, such as gas detectors, respiratory protection, and man-down detection. Electronic PPE typically generate device alerts and critical information using audio alerts, visual alerts, wireless messages, etc. If a worker is wearing hearing protection, which is required in some work environments, these alerts from PPE may not be noticed by the worker, especially in a noisy environment, which could endanger the worker and others around them.

Some hearing protection PPE may generate local device alerts, such as sound exposure level, battery level, and other critical alerts (e.g. related to the hearing protection PPE/earmuffs/headset). However, to better enable a user to receive alerts and notifications from other PPE, the hearing protection earmuffs may be interfaced with the other PPE (carried by or worn by or located in proximity to the user) to collect the critical data generated by the PPE and deliver alerts to the user in a reliable fashion. The hearing protection earmuffs may also be used as a gateway for further communication of the PPE data, such as to cloud storage, central monitoring, and/or similar destinations.

The hearing protection earmuffs may be enabled with wireless communication (such as Bluetooth, and/or Wi-Fi) and a common protocol may be defined to collect data from other PPE devices. The other PPE devices may be enabled with the same wireless communication protocol (and include wireless communication means, such as a transmitter or transceiver), may broadcast critical alerts and/or other PPE data that is to be received by the hearing protection earmuffs. In some embodiments, the data that is broadcast by the PPE devices may be generated by the PPE devices in text format (which will be received by the headset/earmuffs, converted to speech or audio format, and communicated to the user as a voice alert, e.g. by speakers in the earmuffs/headset directed into the user's ear canal) and/or binary format (which can be communicated to a processor for the headset/earmuff (which might then use that binary data to generate an alert via the speakers, for example) and/or other devices, such as a central computer or cloud computing system, for example via a gateway). In some alternate embodiments, (for example, where the other PPE are not configured to transmit alerts via text, but perhaps use an audio or visual alert), the hearing protection earmuff/headset might include a sensor configured (e.g. of the relevant type and oriented towards the other PPE' s alert output) to detect the alert (e.g. audio and/or visual) from the other (e.g. non-hearing protection) PPE device(s).

In some embodiments, the headset/earmuff may also comprise (non-volatile) memory, for example with a look-up table correlating received alerts with preloaded messages and/or voice prompts (for example which might then be transmitted to the speakers and thereby directed into the user's ear canal). And in some embodiments, if multiple alerts are received by the earmuffs/headset in close proximity (e.g. simultaneously or substantially simultaneously), the processor of the headset/earmuff may queue the information (e.g. for display into the ear via speaker and/or transmittal to other devices, for example by gateway) based on criticality (e.g. with the most critical information (as pre-selected and set, for example in memory) being displayed and/or transmitted first). In some embodiments, the criticality may be determined by a PPE device before the alert is sent to the headset. In some embodiments, the criticality may be determined by the headset.

In some embodiments, the headset may not comprise active noise cancellation. In some embodiments, the headset may not comprise a user interface to control or configure the communication between the headset and the PPE device(s). In some embodiments, the headset may not be configured to recognize which PPE device has sent a data message. In some embodiments, a user or wearer of the headset may not request the data messages from the PPE device, the headset will only receive messages generated and broadcast by the PPE device. In some embodiments, the headset may not comprise a microphone nor a voice recognition system. In some embodiments, the headset and the PPE devices may communicate directly with one another without a mobile device, communicator device, or any other device facilitating the communication between the headset and the PPE devices.

This may reduce the number and complexity of the elements required to be in the headset to allow the communication between the PPE devices and the headset, wherein the headset may be configured to receive information from the PPE devices without a complex communication between the PPE devices and the headset. Additionally, the reduced complexity of the headset may result in a cheaper or inexpensive headset, which may therefore appeal to a broader range of consumers, including less sophisticated consumers. Therefore the simplicity of the headset, and the simplified set-up, pairing, and communication between the PPE and the headset may allow a less sophisticated consumer to easily operate the headset and the communication from the PPE devices.

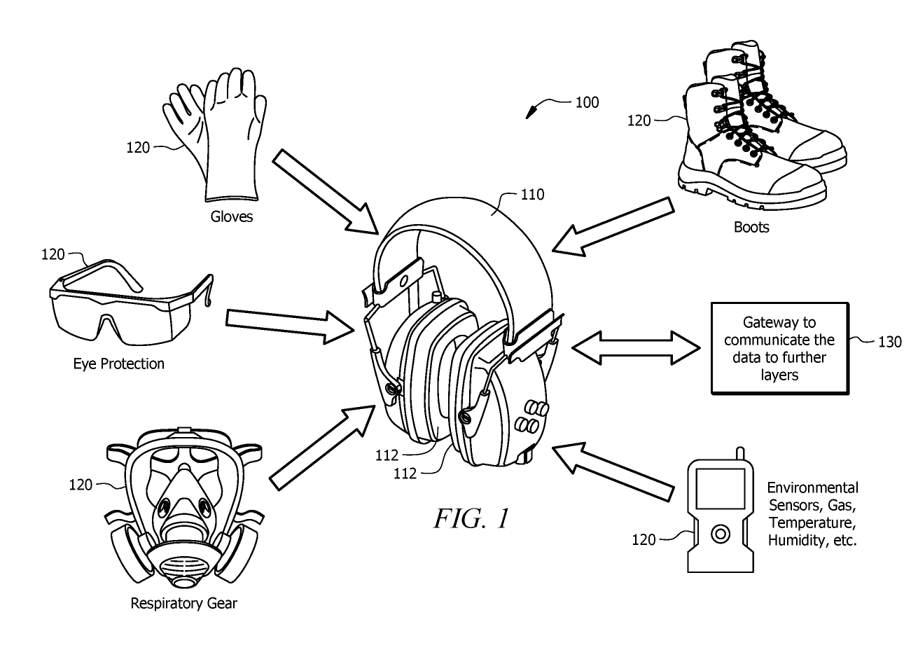

Referring now to FIG. 1, a communication system 100 is shown, wherein the system 100 comprises a headset 110 (which may also be called earmuffs, hearing protection, PPE, or something similar), where the headset 110 may be configured to receive data from one or more PPE devices 120. The PPE devices 120 may be located proximate to the headset 110, for example, when they are worn and/or carried by the user wearing the headset 110. The PPE devices 120 may be configured to generate data messages, and wirelessly broadcast the data messages. The headset 110 may receive the data messages, and may convert the data messages to speech (e.g. via a processor), which may then be broadcast to the user via one or more speakers located within the headset 110. In some embodiments, the headset 110 may be configured to communicate (e.g. wirelessly) with a gateway 130, where the headset 110 may forward data received from the PPE devices 120 via the gateway 130 to other devices and/or storage systems. In some embodiments, the gateway 130 may be part of (e.g. integral with) the headset/earmuff 110 (e.g. the processor of the earmuff 110 may include a transceiver configured to forward received data), while in other embodiments the headset 110 may not include a transmitter/transceiver with sufficient range, but may instead communicate with an alternate gateway device (e.g. a smartphone configured to interact with the earmuff and with other devices, thereby serving as a conduit for longer-range communication). The PPE devices 120 may include, but are not limited to: gloves, eye protection, respiratory protection or gear, boots, and/or environmental sensors (such as temperature sensors, pressure sensors, gas sensors, humidity sensors, etc.).

In some embodiments, the headset 110 may comprise passive noise cancellation, such as in the form of noise cancellation material 112 in the earmuffs of the headset 110. In some embodiments, the headset 110 may not be configured to send any messages to the PPE devices 120. In other words, the communication between the headset 110 and the PPE device 120 may be one-way from the PPE devices 120 to the headset. This may reduce the number and complexity of the elements required to be in the headset 110 to allow the communication between the PPE devices 120 and the headset 110, wherein the headset 110 may be configured to receive information from the PPE devices 120 without a complex communication between the PPE devices 120 and the headset 110. Additionally, the headset 110 may not be configured to control any of the PPE devices 120. In some embodiments, the headset 110 may not recognize the PPE devices 120, but may only receive broadcast messages; while in other embodiments, the headset may pair to the other relevant PPE so that it may recognize the source of the messages/received transmissions.

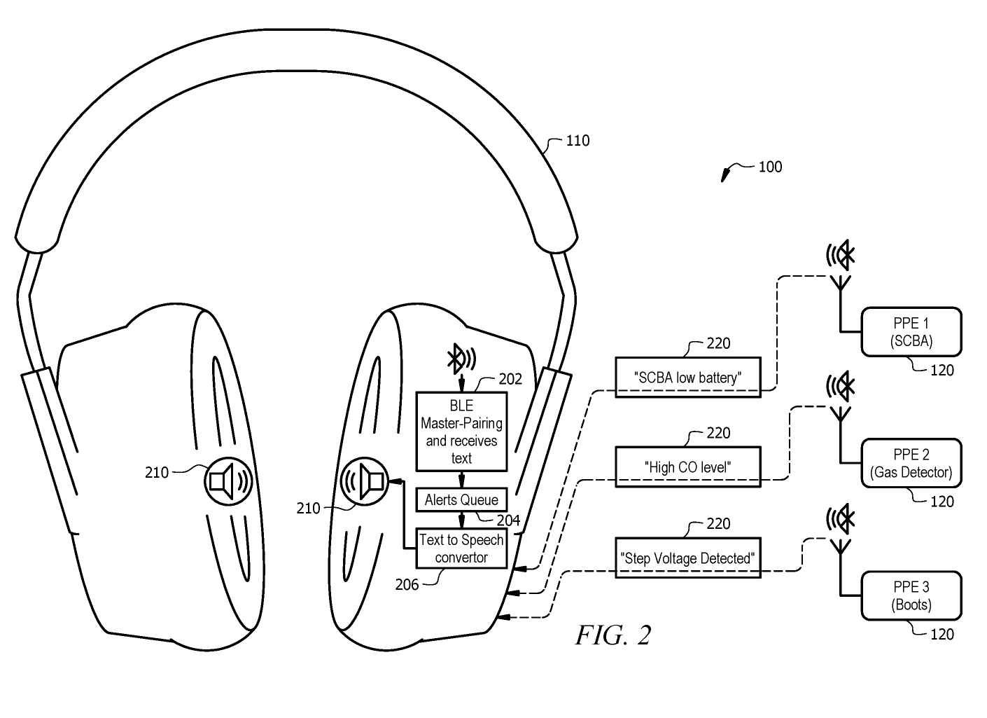

Referring to FIG. 2, another view of the communication system 100 is shown. The PPE devices 120 may generate data messages 220 that may be broadcast by the PPE devices 120. The headset 110 may comprise a wireless interface 202 configured to receive the data messages 220. The headset 110 may comprise a memory 204 configured to at least temporarily store (and possibly queue) the received data messages 220. In some embodiments, the PPE devices 120 may be configured to evaluate and prioritize the data messages 220 before sending to the headset 110. The headset 110 may be configured to rank the plurality of received data messages 220 based on a priority level of each message, and queue the messages in a memory (and/or an alerts queue) 204 to be sent to the speakers 210. In some embodiments, each of the PPE devices 120 may be associated with a priority level (e.g., relative to one another and/or independently), and the received data messages 220 may be ranked based on the priority level of the PPE device 120 that generated the message 220.

In some embodiments, the PPE devices 120 may be configured to determine a priority level for each data message 220 generated by the PPE device 120 based on preset priority levels, which may be stored in a memory of the PPE devices 120 and/or may be accessed by the PPE devices 120. The headset 110 may be configured to recognize the priority level for each data messages 220 received by the headset 110. The priority level may be determined based on the information that is included in the data messages 220. For example, the PPE device 120 may be configured to generate multiple types of messages that may contain a range of information, where the information may be informative, critical, and/or other levels of criticality. Certain PPE devices 120 may generate alarms (e.g., gas detection alarms, temperature level alarms, respiratory level alarms, etc.) that may be deemed critical, and therefore high priority, information. The same PPE devices 120 may also generate low level alerts (such as battery level alerts, lower level sensor alerts, maintenance alerts, etc.) that may be deemed informative, and therefore lower priority. The PPE devices 120 may also generate any range of criticality of alerts, where the priority levels may comprise at least two levels, and may in some embodiments comprise more than two levels. The headset 110 may receive and communicate all of the data messages 220 generated by the PPE devices 120, but higher priority messages (e.g., alarms) may be ranked and queued above lower priority messages (e.g., alerts).

The headset 110 may comprise a converter 206 configured to convert the received messages to audio (or speech), and configured to send the converted messages to one or more speakers 210 in the headset 110. The converter 206 may be configured to process messages in text format and convert them to speech format to be played by the speakers 210. The converter 206 may be configured to processing messages in binary format and convert them to speech format to be played by the speakers 210. In some embodiments, the data messages 220 may be ranked and queued in the memory 204 before they are processed by a text to speech converter 206. In other embodiments, the alerts may be processed by the converter 206 before they are ranked and queued.

In some embodiments, each of the one or more PPE 120 may comprise one or more processors, at least one memory, and an application stored in the memory and executed by the processor that is configured to collect data associated with the PPE 120, process the data to determine if a message should be sent to the headset, generate the one or more data messages 220, and associate the one or more data messages 220 with a priority level. The priority level may be chosen from a preset list of priority levels, and the preset list of priority levels may be common across a plurality of PPE devices 120 (in some embodiments, all of the PPE devices 120 communicating with the headset 110).

In the embodiment shown in FIG. 2, the system 100 may communicate wirelessly using Bluetooth protocol. In some embodiments, each of the PPE devices 120 may comprise a near-field communication (NFC) module and the headset 110 may comprise an NFC module configured to interact to initiate a Bluetooth pairing between the headset 110 and the PPE devices 120. In other words, NFC between the two devices (when they are in close proximity), may act to link the two devices and to automatically activate Bluetooth transmission of data from the PPE devices 120 to the now linked headset 110. When the PPE device 120 is placed in proximity (e.g. within NFC range, such as within 10 cm or within 3 cm) to the headset 110, a NFC peer-to-peer (P2P) data exchange may occur between the headset 110 and the PPE device(s) 120, where the data exchange may include identification and connection data associated with the PPE device 120 and/or headset 110.

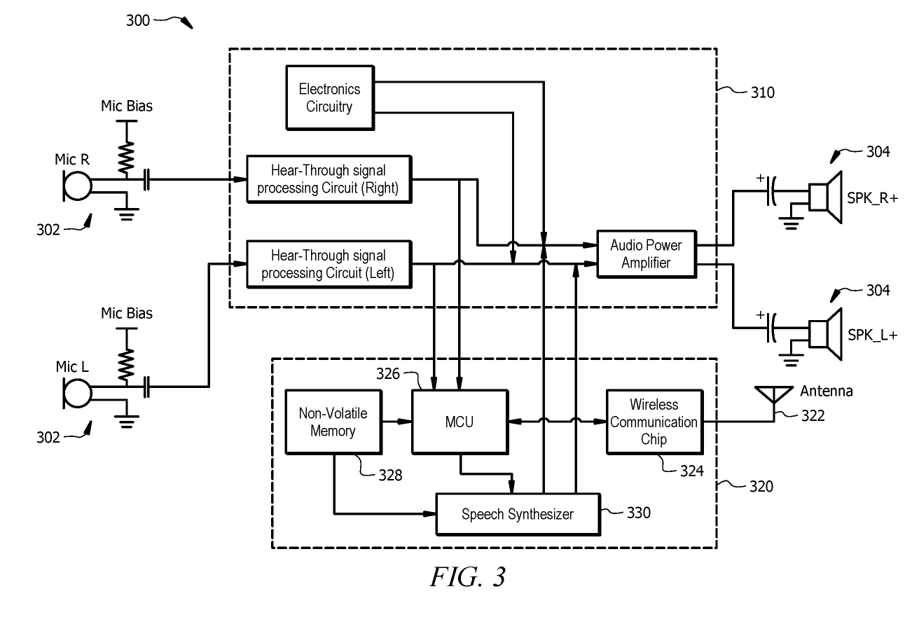

Referring to FIG. 3, a diagram of an electronics system 300 is shown, wherein the electronics system 300 may be located within a headset 110 (described above). The electronics system 300 may comprise one or more microphones 302 and one or more speakers 304. The electronics system 300 may also comprise additional circuitry 310 configured to receive, process, and communicate data between the microphones 302 and the speakers 304.

Additionally, the electronics system 300 may comprise a wireless communication module 320 configured to receive, process, and communicate data from outside devices (e.g., PPE devices described above) to the headset 110. The wireless communication module 320 may comprise a wireless antenna 322 and a wireless communication chip 324 configured to receive and possibly transmit wireless data. The wireless communication module 320 may comprise a processor (or microcontroller unit (MCU)) 326 and a memory 328. The wireless communication module 320 may also comprise a speech synthesizer (or converter) 330 configured to receive data via the wireless communication chip 324, and convert the received data to speech (or audio) format. The converted data may then be forwarded to the one or more speakers 304 to be heard by the user.

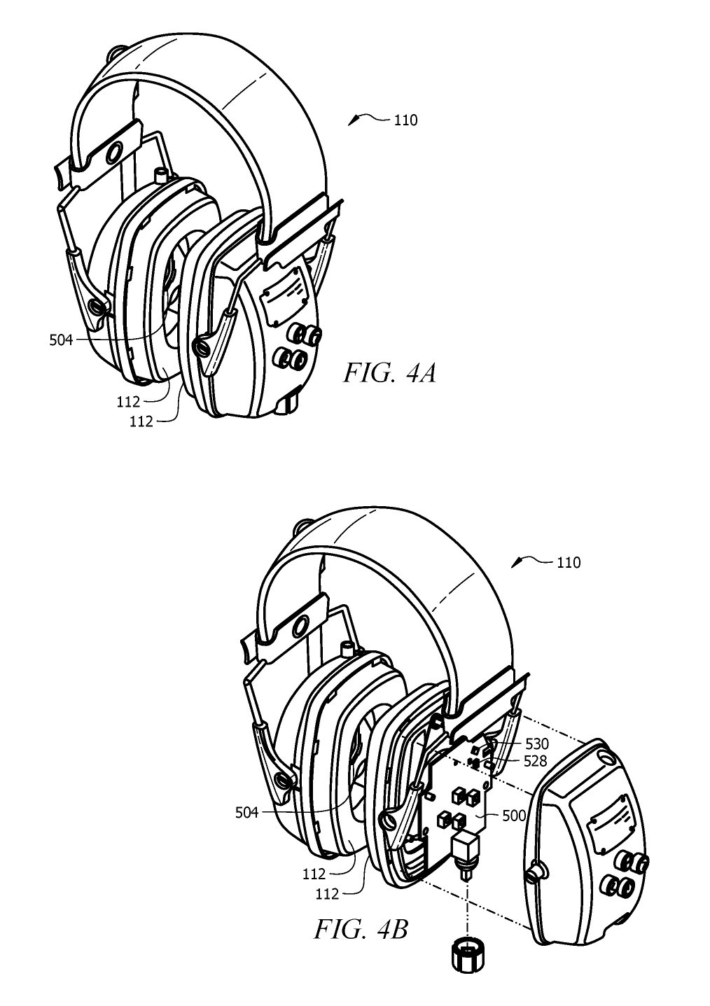

FIGS. 4A-4B illustrate detailed views of an exemplary embodiment of a headset 110, where the headset 110 may comprise an electronics system 500 configured to receive and process messages from one or more PPE devices, as described above. The electronics system 500 may comprise a speech synthesizer (or converter) 530, as described above, and a non-volatile memory 528, as described above, which may comprise pre-loaded voice prompts. The pre-loaded or pre-set voice prompts may be associated with expected information to be received from one or more PPE devices. The electronics system 500 may comprise and/or communicate with one or more speakers 504 within the headset 110.

In an embodiment, a wireless communication system may comprise at least one personal protection equipment (PPE) device configured to generate messages and wirelessly communicate the generated messages; and a hearing protection headset comprising passive noise cancellation material configured to protect a user from harmful sound exposure; a wireless communication module configured to wirelessly receive one or more messages from the at least one PPE device, and convert the received message to speech (or audio) format; and one or more speakers configured to communicate the converted message to the user.

Having described various devices and methods herein, exemplary embodiments or aspects can include, but are not limited to:

In a first embodiment, a wireless communication system may comprise at least one personal protection equipment device configured to generate messages and wirelessly communicate the generated messages; and a hearing protection headset comprising passive noise cancellation material configured to protect a user from harmful sound exposure; a wireless communication module configured to wirelessly receive one or more messages from the at least one personal protection equipment device, and convert the received message to speech format; and one or more speakers configured to communicate the converted message to the user.

A second embodiment can include the wireless communication system of the first embodiment, wherein the personal protection equipment device is further configured to determining a priority level for the messages generated by the personal protection equipment.

A third embodiment can include the wireless communication system of the second embodiment, wherein the hearing protection headset comprises at least one processor configured to receive a plurality of messages from one or more personal protection equipment device; rank the plurality of messages based on the determined priority level; and queue the plurality of messages to be communicated to the user in the ranked order.

A fourth embodiment can include the wireless communication system of any of the first through third embodiments, wherein the at least one personal protection equipment device comprises a plurality of personal protection equipment devices, and wherein each of the plurality of personal protection equipment devices is associated with a priority level.

A fifth embodiment can include the wireless communication system of the fourth embodiment, wherein the hearing protection headset comprises at least one processor configured to receive a plurality of messages from the plurality of personal protection equipment devices, wherein the messages are associated with the personal protection equipment devices; rank the plurality of messages based on the priority level of the personal protection equipment devices associated with the messages; and queue the plurality of messages to be communicated to the user in the ranked order.

A sixth embodiment can include the wireless communication system of any of the first through fifth embodiments, wherein the wireless communication module of the headset comprises a near-field communication module, and wherein each of the at least one personal protection equipment device comprises a near-field communication module.

A seventh embodiment can include the wireless communication system of the sixth embodiment, wherein, when the personal protection equipment device is placed in proximity to the headset within near-field communication range, the hearing protection headset comprises at least one processor configured to complete a near-field communication peer-to-peer data exchange between the headset and the personal protection equipment device; and automatically activate a Bluetooth connection between the headset and the personal protection equipment device via the peer-to-peer data exchange.

An eighth embodiment can include the wireless communication system of any of the first through seventh embodiments, wherein the wireless communication module of the headset comprises a Bluetooth communication module; and a text to speech converter.

In a ninth embodiment, a method for communicating data from a personal protection equipment device to a headset may comprise generating at least one message, by a personal protection equipment device, comprising information related to the personal protection equipment device; wirelessly communicating the generated message from the personal protection equipment device; receiving, by a hearing protection headset, one or more of the generated messages from the at least one personal protection equipment device; converting, by the hearing protection headset, the received message to speech format; and communicating, via one or more speaker within the heating protection headset, the converted message to the user.

A tenth embodiment can include the method of the ninth embodiment, further comprising determining a priority level for the message generated by the personal protection equipment; receiving a plurality of messages from one or more personal protection equipment device; ranking the plurality of messages based on the determined priority level; and queuing the plurality of messages to be communicated to the user in the ranked order.

An eleventh embodiment can include the method of the tenth embodiment, wherein determining the priority level is performed by the personal protection equipment device.

A twelfth embodiment can include the method of any of the ninth through eleventh embodiments, further comprising receiving a plurality of messages from a plurality of personal protection equipment devices, wherein the messages are associated with the personal protection equipment devices; determining a priority level for each of the plurality of personal protection equipment devices; ranking the plurality of messages based on the determined priority level of the personal protection equipment devices associated with the messages; and queuing the plurality of messages to be communicated to the user in the ranked order.

A thirteenth embodiment can include the method of any of the ninth through twelfth embodiments, further comprising protecting a user from harmful sound exposure via passive noise cancellation material within the hearing protection headset.

A fourteenth embodiment can include the method of any of the ninth through thirteenth embodiments, further comprising placing the personal protection equipment device in proximity to the headset within near-field communication range; completing a near-field communication peer-to-peer data exchange between the headset and the personal protection equipment device; and automatically activating a Bluetooth connection between the headset and the personal protection equipment device via the peer-to-peer data exchange.

A fifteenth embodiment can include the method of the fourteenth embodiment, wherein wirelessly communicating the generated message from the personal protection equipment device, and receiving the generated message by the hearing protection headset is completed over the Bluetooth connection.

In a sixteenth embodiment, a hearing protection headset may comprise passive noise cancellation material configured to protect a user from harmful sound exposure; a wireless communication module configured to wirelessly receive one or more data messages generated by at least one personal protection equipment device; a converter configured to convert the received message to speech format; and one or more speaker configured to communicate the converted message to the user.

A seventeenth embodiment can include the hearing protection headset of the sixteenth embodiment, wherein the data messages comprise a priority level, and wherein the hearing protection headset comprises at least one processor configured to receive a plurality of messages from one or more personal protection equipment devices; rank the plurality of messages based on the determined priority level; and queue the plurality of messages to be communicated to the user in the ranked order.

An eighteenth embodiment can include the hearing protection headset of the sixteenth or seventeenth embodiments, wherein each of the at least one personal protection equipment device comprises an associated priority level, and wherein the hearing protection headset comprises at least one processor configured to receive a plurality of messages from the plurality of personal protection equipment devices, wherein the messages are associated with the personal protection equipment devices; rank the plurality of messages based on the priority level of the personal protection equipment devices associated with the messages; and queue the plurality of messages to be communicated to the user in the ranked order.

A nineteenth embodiment can include the hearing protection headset of any of the sixteenth through eighteenth embodiments, wherein the wireless communication module of the headset comprises a near-field communication module configured to interface with a near-field communication module of the at least one personal protection equipment device.

A twentieth embodiment can include the hearing protection headset of the nineteenth embodiment, wherein, when the personal protection equipment device is placed in proximity to the headset within near-field communication range, the hearing protection headset comprises at least one processor configured to complete a near-field communication peer-to-peer data exchange between the headset and the personal protection equipment device; and automatically activate a Bluetooth connection between the headset and the personal protection equipment device via the peer-to-peer data exchange.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. Alternative embodiments that result from combining, integrating, and/or omitting features of the embodiment(s) are also within the scope of the disclosure. Accordingly, the scope of protection is not limited by the description set out above, but is defined by the claims which follow that scope including all equivalents of the subject matter of the claims. Each and every claim is incorporated as further disclosure into the specification and the claims are embodiment(s) of the present invention(s). Furthermore, any advantages and features described above may relate to specific embodiments, but shall not limit the application of such issued claims to processes and structures accomplishing any or all of the above advantages or having any or all of the above features.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure. Specifically and by way of example, although the headings might refer to a “Field,” the claims should not be limited by the language chosen under this heading to describe the so-called field. Further, a description of a technology in the “Background” is not to be construed as an admission that certain technology is prior art to any invention(s) in this disclosure. Neither is the “Summary” to be considered as a limiting characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of the claims shall be considered on their own merits in light of this disclosure, but should not be constrained by the headings set forth herein.

Use of broader terms such as “comprises,” “includes,” and “having” should be understood to provide support for narrower terms such as “consisting of,” “consisting essentially of,” and “comprised substantially of.” Use of the terms “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A wireless communication system comprising:
at least one personal protection equipment device configured to generate messages and wirelessly communicate the generated messages; and
a hearing protection headset comprising:
passive noise cancellation material configured to protect a user from harmful sound exposure;
a wireless communication module configured to wirelessly receive one or more messages from the at least one personal protection equipment device, and convert the received message to speech format; and
one or more speakers configured to communicate the converted message to the user.

2. The wireless communication system of claim 1, wherein the personal protection equipment device is further configured to determining a priority level for the messages generated by the personal protection equipment device(s).

3. The wireless communication system of claim 2, wherein the hearing protection headset comprises at least one processor configured to:
receive a plurality of messages from one or more personal protection equipment device;
rank the plurality of messages based on the determined priority level; and
queue the plurality of messages to be communicated to the user in the ranked order.

4. The wireless communication system of claim 1, wherein the at least one personal protection equipment device comprises a plurality of personal protection equipment devices, and wherein each of the plurality of personal protection equipment devices is associated with a priority level.

5. The wireless communication system of claim 4, wherein the hearing protection headset comprises at least one processor configured to:
receive a plurality of messages from the plurality of personal protection equipment devices, wherein the messages are associated with the personal protection equipment devices;
rank the plurality of messages based on the priority level of the personal protection equipment devices associated with the messages; and
queue the plurality of messages to be communicated to the user in the ranked order.

6. The wireless communication system of claim 1, wherein the wireless communication module of the headset comprises a near-field communication module, and wherein each of the at least one personal protection equipment device comprises a near-field communication module.

7. The wireless communication system of claim 6, wherein, when the personal protection equipment device is placed in proximity to the headset within near-field communication range, the hearing protection headset comprises at least one processor configured to:
complete a near-field communication peer-to-peer data exchange between the headset and the personal protection equipment device; and
automatically activate a Bluetooth connection between the headset and the personal protection equipment device via the peer-to-peer data exchange.

8. The wireless communication system of claim 1, wherein the wireless communication module of the headset comprises a Bluetooth communication module; and a text to speech converter.

9. A method for communicating data from a personal protection equipment device to a headset comprising:
generating at least one message, by a personal protection equipment device, comprising information related to the personal protection equipment device;
wirelessly communicating the generated message from the personal protection equipment device;
receiving, by a hearing protection headset, one or more of the generated messages from the at least one personal protection equipment device;
converting, by the hearing protection headset, the received message to speech format; and
communicating, via one or more speaker within the heating protection headset, the converted message to the user.

10. The method of claim 9, further comprising:
determining a priority level for the message generated by the personal protection equipment;
receiving a plurality of messages from one or more personal protection equipment device;
ranking the plurality of messages based on the determined priority level; and
queuing the plurality of messages to be communicated to the user in the ranked order.

11. The method of claim 10, wherein determining the priority level is performed by the personal protection equipment device.

12. The method of claim 9, further comprising:
receiving a plurality of messages from a plurality of personal protection equipment devices, wherein the messages are associated with the personal protection equipment devices;
determining a priority level for each of the plurality of personal protection equipment devices;
ranking the plurality of messages based on the determined priority level of the personal protection equipment devices associated with the messages; and
queuing the plurality of messages to be communicated to the user in the ranked order.

13. The method of claim 9, further comprising protecting a user from harmful sound exposure via passive noise cancellation material within the hearing protection headset.

14. The method of claim 9, further comprising:
placing the personal protection equipment device in proximity to the headset within near-field communication range;
completing a near-field communication peer-to-peer data exchange between the headset and the personal protection equipment device; and
automatically activating a Bluetooth connection between the headset and the personal protection equipment device via the peer-to-peer data exchange.

15. The method of claim 14, wherein wirelessly communicating the generated message from the personal protection equipment device, and receiving the generated message by the hearing protection headset is completed over the Bluetooth connection.

16. A hearing protection headset comprising:
passive noise cancellation material configured to protect a user from harmful sound exposure;
a wireless communication module configured to wirelessly receive one or more data messages generated by at least one personal protection equipment device;
a converter configured to convert the received message to speech format; and
one or more speakers configured to communicate the converted message to the user.

17. The hearing protection headset of claim 16, wherein the data messages comprise a priority level, and wherein the hearing protection headset comprises at least one processor configured to:
receive a plurality of messages from one or more personal protection equipment device;
rank the plurality of messages based on the determined priority level; and
queue the plurality of messages to be communicated to the user in the ranked order.

18. The hearing protection headset of claim 16, wherein each of the at least one personal protection equipment device comprises an associated priority level, and wherein the hearing protection headset comprises at least one processor configured to:
receive a plurality of messages from the plurality of personal protection equipment devices, wherein the messages are associated with the personal protection equipment devices;
rank the plurality of messages based on the priority level of the personal protection equipment devices associated with the messages; and
queue the plurality of messages to be communicated to the user in the ranked order.

19. The hearing protection headset of claim 16, wherein the wireless communication module of the headset comprises a near-field communication module configured to interface with a near-field communication module of the at least one personal protection equipment device.

20. The hearing protection headset of claim 19, wherein, when the personal protection equipment device is placed in proximity to the headset within near-field communication range, the hearing protection headset comprises at least one processor configured to:
complete a near-field communication peer-to-peer data exchange between the headset and the personal protection equipment device; and
automatically activate a Bluetooth connection between the headset and the personal protection equipment device via the peer-to-peer data exchange.
